(19) United States
(12) Patent Application Publication
(10) Pub. No.: US 2021/0304268 A1
(43) Pub. Date: Sep. 30, 2021

(54) ELECTRONIC PROCUREMENT SYSTEM WITH A VIRTUAL CATALOG

(71) Applicant: Zycus Infotech Pvt. Ltd., Mumbai (IN)

(72) Inventors: Vijesh Bhakta, Mumbai (IN); Bikash Mohanty, Mumbai (IN)

(73) Assignee: Zycus Infotech Pvt. Ltd., Mumbai (IN)

(21) Appl. No.: 17/206,595

(22) Filed: Mar. 19, 2021

(30) Foreign Application Priority Data
Mar. 26, 2020 (IN) 202021013129

(51) Int. Cl. G06Q 30/06; G06F 16/953; G06F 16/958

(52) U.S. Cl. CPC G06Q 30/0603; G06F 16/958; G06F 16/953; G06Q 30/0623

(57) ABSTRACT

An electronic procurement system (2) characterized by the presence of a virtual catalog (12) in addition to the internal hosted catalog (4), wherein the virtual catalog (12) is comprised of a list of items not found in the internal hosted catalog (4) of the electronic procurement system (2), wherein the list of items present in the virtual catalog (12) are fetched from punchout websites (8) connected with the electronic procurement system (2), wherein the process of creation of the virtual catalog (12) is facilitated by a processing means (6) and broadly comprises steps such as data search, data extraction, data storage, data alignment, data collation and data publishing, wherein the data refers to the query item name (3) entered by the requester (1), and wherein the electronic procurement system (2) is easy to use, convenient, efficient, user friendly and eliminates cumbersome data requisition steps.

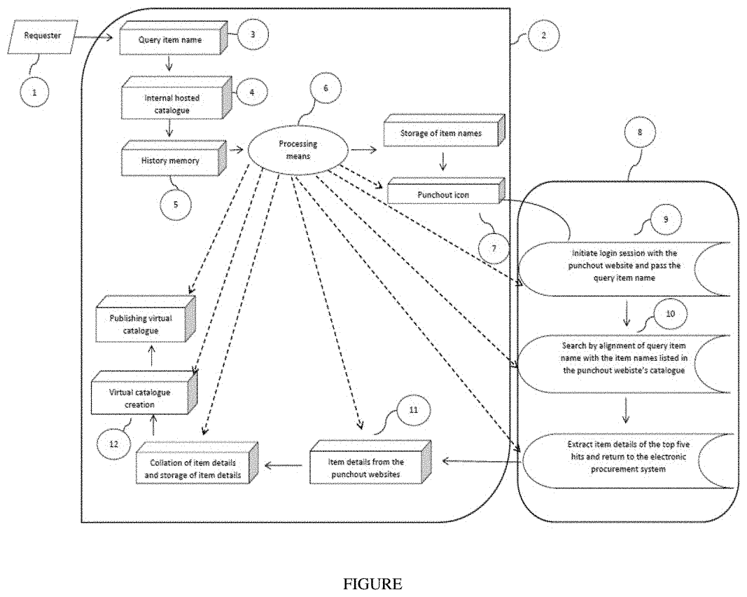

### CROSS-REFERENCE TO RELATED APPLICATION

The instant application claims priority to Indian Patent Application Serial No. 202021013129, filed Mar. 26, 2020, pending, the entire specification of which is expressly incorporated herein by reference.

### FIELD OF THE INVENTION

The present invention relates to an electronic procurement system. Particularly, the present invention relates to an electronic procurement system comprising of a virtual catalog in addition to the internal hosted catalog provided within the system. The invention further relates to a process of creation of the virtual catalog within the electronic procurement system.

### BACKGROUND OF THE INVENTION

Electronic procurement refers to the business to business or business to customer or business to government purchase process of requisitioning, ordering and purchasing goods and services over the internet. Electronic procurement processes provide their users substantial benefits such as cost savings, shorter purchasing cycles, improved inventory control and transparency, to name a few. Electronic procurement systems typically comprise of online catalogs representing a list of items available for the purchase. Usually these systems consist of internal hosted catalogs representing a limited set of items. However, many a times an event may arise wherein the buyer or the requester is unable to find the query item in these internal catalogs thus creating an obstacle for him to raise a requisition within the electronic procurement system. In some of the electronic procurement systems available in the market, the requester is redirected to the external links for finding the query item at those locations. However, this becomes very cumbersome for the requester and hence makes the process of electronic procurement inconvenient.

U.S. Pat. No. 5,319,542 discloses a system that facilitates the user in the electronically ordering items from suppliers. The system comprises an electronic catalog and an electronic requisition facility. The electronic catalog includes a public catalog and a private catalog. The public catalog is stored in a publicly available database for access by customer/requesters. The private catalog is resident on a customer's computer system and may contain unique pricing data based on pricing agreements. The electronic requisition facility is used by the customers/requesters to electronically create purchase requisitions through the appropriate approval process within the enterprise. Requisitions are then processed through the customer's procurement system and transmitted electronically as purchase orders to suppliers.

In U.S. Pat. No. 8,352,326, a virtual business transaction is implemented between a first virtual world and a second virtual world by providing a searchable catalog that includes one or more items each comprising a virtual good, a virtual service, a real good, or a real service. An object representation is stored for each of the items. Each of the stored object representations is associated with metadata comprising any of digital rights metadata, ownership metadata, identity metadata, payment method metadata, or currency detail metadata. A set of transformation algorithms are established that are customized through a rule set. A request is received specifying a copying, modifying, or reselling of an item selected from the items in the searchable catalog. The copying, modifying, or reselling of the item from a first virtual world to a second virtual world is implemented using the set of transformation algorithms An exchange of virtual currency is implemented between the first virtual world and the second virtual world using the set of transformation algorithms

However, the prior arts fail to provide an electronic procurement system wherein there is a provision of an additional catalog consisting a list of item names, apart from the internal hosted catalog being included within the electronic procurement system itself and which is accessible to the requester. The present invention thus overcomes the limitations of the prior arts and provides an electronic procurement system comprising of a virtual catalog within the electronic procurement system in addition to the internal hosted catalog.

### Objects of the Invention

An object of the present invention is to provide an electronic procurement system comprising of a virtual catalog in addition to the internal hosted catalog present within the system.

Another object of the present invention is to provide an electronic procurement system which creates a virtual catalog based on the search queries entered by the requester which are not listed in the internal hosted catalog of the electronic procurement system.

Yet another object of the present invention is to provide a process for creation of a virtual catalog within the electronic procurement system itself.

Yet another object of the present invention is to provide an electronic procurement system which makes use of punchout websites connected with the electronic procurement system for searching the relevant items not found in the internal hosted catalog of the system, thus facilitating in the creation of a virtual catalog.

Yet another object of the preset invention is to provide a comprehensive list of available items to the requester by simultaneously displaying the items in the internal hosted catalog as well as the items in the virtual catalog within the electronic procurement system itself.

Yet another object of the present invention is to provide an electronic procurement system which makes it easy and convenient for the requester to raise a requisition even when the search query entered by him is not found in the internal hosted catalog of the electronic procurement system.

Yet another object of the present invention is to provide an electronic procurement system which is simple, convenient to use and user friendly.

Yet another object of the present invention is to provide an electronic procurement system which displays all possible relevant options to the requester prior to raising the final requisition request.

### SUMMARY OF THE INVENTION

The present invention relates to an electronic procurement system. Particularly the present invention relates to an electronic procurement system primarily aimed at the creation of a virtual catalog in an event wherein the query item name entered by the requester is not found within the internal hosted catalog of the electronic procurement system.

In one aspect, the present invention provides an electronic procurement system which is connected with a few punchout websites. In an event wherein the query item name is not found in the internal hosted catalog of the electronic procurement system, the query item name is searched for, in the corresponding punchout websites and the best relevant results are extracted and returned to the electronic procurement system.

In another aspect, the present invention provides an electronic procurement system which involves a processing means which facilitates data exchange between the electronic procurement system and the punchout websites. The processing means conducts a search for the query item name in the catalog of the punchout websites by alignment of keywords, identifies the best relevant hits, extracts the corresponding item details and returns back the same to the electronic procurement system. Based on the list of such item details fetched from the punchout websites, the processing means further creates and publishes a virtual catalog involving these item details, within the electronic procurement system itself.

In yet another aspect, the present invention provides an electronic procurement system comprising of a virtual catalog in addition to the internal hosted catalog, wherein the virtual catalog creation is facilitated by a processing means. Further, the virtual catalog so created is tied to the decision rules of the processing means to refresh or update the catalog on a periodic basis.

### BRIEF DESCRIPTION OF THE DRAWINGS

The Figure illustrates the process for creation of a virtual catalog within the electronic procurement system.

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

Referring to the FIG., a preferred embodiment of the present invention, when the requester (1) enters a search query in the form of a free text query item name (3) in the electronic procurement system (2), the query item name (3) is searched within the internal hosted catalog (4) of the electronic procurement system (2). In an event wherein the query item name (3) is not found within the internal hosted catalog (4), the query item name (3) is saved in the history memory (5) of the electronic procurement system (2). The electronic procurement system (2) makes use of a processing means (6) which further implements all the steps for creation of a virtual catalog (12). It is to be noted that the broken arrows in the FIG. represent the steps which are facilitated by the processing means (6).

Initially, the processing means (6) extracts all such query item names (3) from the history memory (5) of the electronic procurement system (2) and stores the list of all such item names (3). In an event wherein, the search query item name (3) is not found within the internal hosted catalog (4), at least one punchout icon (7) is displayed on the screen of the requester (1). As soon as the requester (1) clicks on a particular punchout icon (7), the processing means (6) is invoked to initiate the process of performing a keyword search in the corresponding punchout website (8). The processing means (6) at this stage initiates a login session (9) with the punchout website (8) and passes on the search query item name (3) to the punchout website (8). The processing means (6) conducts a search in the punchout websites (8) by aligning the search query item name (3) with the item names listed in the punchout website's catalog (10). The item details (11) of the top five hits of the search process so conducted are extracted and returned to the electronic procurement system (2). Once the item details (11) of the top five hits are returned to the electronic procurement system (2), all the item details (11) are collated by the processing means (6) and stored as a list. This list of item details (11) is used to create a virtual catalog (12) which is further published by the processing means (6) on the electronic procurement system (2) and displayed to the requester (1).

Further, the virtual catalog (12) is tied with the decision rules of the processing means (6) to refresh or update the virtual catalog (12), the rules being predefined but also having a provision to be configured at a later stage. Based on the category of items present in the virtual catalog (12), the processing means (6) recognizes those items for different level of urgency for the virtual catalog (12) update i.e. whether to update the virtual catalog (12) on a daily, monthly or quarterly basis. For instance, the processing means (6) can recognize that items like laptops are required to be refreshed every month whereas items like chairs are required to be refreshed every quarter. Based in this recognition, the processing means (6) fetches the data connected to that particular virtual catalog (12) and refresh the item and price data.

In an embodiment of the present invention, in case of an event wherein the requester (1) finds the search query item name (3) in the internal hosted catalog (4) of the electronic procurement system (2) and adds it to the shopping cart, before clicking on submit, the requester is still presented with a list of better options from the virtual catalog (12) generated by any previous relevant search queries.

Punchout icons (7) refer to a link of external websites of the suppliers or vendors, available on the electronic procurement system (2). The requester (1) can directly click on the punchout icon (7) to find a particular item on the punchout website (8) linked to that particular punchout icon (7). Once the punchout icon (7) is clicked, the requester (1) is directed to the corresponding punchout website (8) where the requester (1) can select an item which will be added to the cart of the electronic procurement system (2). At the time of the check-out, the requester is directed back to the electronic procurement system (2).

In a preferred embodiment of the present invention, the electronic procurement system (2) is enabled to run on a desktop computer. In another embodiment of the present invention, the electronic procurement system (1) may also be enabled to operate on a mobile phone.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA,” a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices), multimedia Internet enabled cellular telephones (e.g., the BLACKBERRY STORM™, and similar personal electronic devices that include a wireless communication module, processor and memory,

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An electronic procurement system, comprising:
a virtual catalog;
an internal hosted catalog;
wherein the virtual catalog comprises a list of items not found in the internal hosted catalog; and
wherein the list of items present in the virtual catalog are fetched from punchout websites connected with the electronic procurement system, such that a process for creation of the virtual catalog is facilitated by a processing means and comprises the steps of:
searching all historical requisitions made in the electronic procurement system;
extracting a query item name;
storing the list of all such item names;
invoking the processing means to initiate the process of performing a keyword search, in the corresponding punchout website when a requester clicks on the punchout icon of that particular punchout website;
initiating a login session with the punchout website and passing on the item name to the punchout website;
initiating a search in the punchout website by aligning the item name with the item names listed in the punchout website's catalog;
extracting the item details of the top five hits of the search results and returning them to the electronic procurement system;
collating and storing all the item details;
creating a virtual catalog which includes the collated and stored item details; and
publishing the virtual catalog on the electronic procurement system.

2. The electronic procurement system as claimed in claim 1, wherein both the internal hosted catalog and the virtual catalog are represented within the electronic procurement system itself, providing the requester with a comprehensive list of items available in both of the catalogs.

3. The electronic procurement system as claimed in claim 1, wherein the punch out websites are external websites of suppliers or vendors and are connected with the electronic procurement system.

4. The electronic procurement system as claimed in claim 1, wherein the requester is directed to a particular punchout website upon clicking the punchout icon corresponding to that punchout website.

5. The electronic procurement system as claimed in claim 1, wherein the query item name is in the form of free text.

6. The electronic procurement system as claimed in claim 1, wherein an exchange of data between the electronic procurement system and the punchout websites is facilitated by a processing means.

7. The electronic procurement system as claimed in claim 1, wherein the processing means is also equipped to provide a list of other item options fetched from the item names present in the virtual catalog, even in an event wherein the requester finds the query item name in the internal hosted catalog of the electronic procurement system.

8. The electronic procurement system as claimed in claim 1, wherein the virtual catalog is tied with decision rules of the processing means to periodically refresh or update the virtual catalog.
